(19) United States
(12) Patent Application Publication
(10) Pub. No.: US 2008/0147404 A1
(43) Pub. Date: Jun. 19, 2008

(54) System and methods for accent classification and adaptation

(75) Inventors: Wai Kat Liu, Hong Kong (HK); Pascale Fung, Clear Water Bay (HK)

Correspondence Address: FOLEY HOAG, LLP;PATENT GROUP, WORLD TRADE CENTER WEST, 155 SEAPORT BLVD, BOSTON, MA, 02110, US

(73) Assignee: NuSuara Technologies SDN BHD, Petaling Jaya (MY)

(21) Appl. No.: 09/858,334

(22) Filed: May 15, 2001

Related U.S. Application Data
(60) Provisional application No. 60/204,204, filed on May 15, 2000.

(51) Int. Cl. G10L 15/00

(52) U.S. Cl. 704/256.2; 704/244; 704/E15.008

(57) ABSTRACT

Speech is processed that may be colored by speech accent. A method for recognizing speech includes maintaining a model of speech accent that is established based on training speech data, wherein the training speech data includes at least a first set of training speech data, and wherein establishing the model of speech accent includes not using any phone or phone-class transcription of the first set of training speech data. Related systems are also presented. A system for recognizing speech includes an accent identification module that is configured to identify accent of the speech to be recognized; and a recognizer that is configured to use models to recognize the speech to be recognized, wherein the models include at least an acoustic model that has been adapted for the identified accent using training speech data of a language, other than primary language of the speech to be recognized, that is associated with the identified accent. Related methods are also presented.

### RELATED APPLICATIONS

The present application is related to, and claims the benefit of priority from, the following commonly-owned U.S. provisional patent application(s), the disclosures of which are hereby incorporated by reference in their entirety, including any incorporations-by-reference, appendices, or attachments thereof, for all purposes:

Ser. No. 60/204,204, filed on May 15, 2000, and entitled SYSTEM AND METHODS FOR ACCENT CLASSIFICATION AND ADAPTATION.

### BACKGROUND OF THE INVENTION

The following abbreviations will be used:
AA Accent Adapted,
AD Accent Dependent,
AI Accent Independent,
ASR Automatic Speech Recognisation,
E Energy,
F0 Fundamental Frequency,
F1 First Formants,
F2 Second Formants,
F3 Third Formants,
HMM Hidden Markov Model, and
IPA International Phonetic Alphabet.

Automatic speech recognition technology has developed rapidly in the recent past. Applications of this technology have been seen everywhere such as voice dialing in mobile phone handsets and telephone response systems used by many big companies. As automatic speech recognition systems become more and more popular, the scope and type of people using them increase. The variety of speaker differences, especially accent differences, has made a challenge or problem to these systems. Automatic speech recognition systems are usually trained using speech spoken by people from one or several accent groups. When the system is later used by a user with an accent that differs from the training accent(s), the performance of the speech recognition system degrades.

The degradation is attributable to both acoustic and phonological differences between languages. There are many languages in the world. Some languages are closer to each other than are others. For Example, English and German are closer to each other than either is to Chinese. Languages differ from each other in terms of their phoneme inventory, grammar, stress pattern, etc. People will acquire a certain speaking style from their language. As Asian languages such as Chinese are very different from English, there are great differences in speaking styles between native speakers of Asian languages and native speakers of English.

FIG. 1A is a diagram of a typical automatic speech recognition (ASR) system 10. The user input speech 12 is analyzed by a feature analyzer and important parameters 16 are extracted by the front-end spectral analysis block 14. These parameters are then fed into a recognizer 18. The recognizer 18 will try to guess the spoken words using knowledge of phonemes, dictionary and grammar of a language. These knowledge are computed statistically beforehand and stored in acoustic models 20, lexicon 22 and language models 24, respectively, as shown in FIG. 1A.

The details of conventional ASR systems are well-known, and will be further discussed. Generally, a conventional ASR system cannot perform well when the user has a regional accent different from that of the training speakers. Performance deteriorates further when the standard language is not the first language of the speaker. For example, in Hong Kong, most people can speak English. However, their English has a particular local Cantonese accent. People can generally point out that there are hearable differences between native English and native Cantonese speakers when they both speaking English. Such differences make many speech recognition systems have a significant drop in performance.

This problem is attributable to the fact that most ASR systems are not capable to cope with the acoustic and pronunciation differences from the user with a different accent. The acoustic models of most ASR systems are trained by the speech of a certain accent group. Further, the lexicon is also made of the common pronunciation from the same training accent. When there is a mismatch of the accent between the user and the training speakers from which the ASR system is trained with, the acoustic models and the lexicon too frequently fail to recognize the user speech.

### SUMMARY OF THE INVENTION

The present invention relates to processing of speech that may be colored by speech accent. According to an embodiment of the present invention, in an information processing system, there is a method for recognizing speech to be recognized. The method includes the steps of: maintaining a model of speech accent that is established based on training speech data, wherein the training speech data includes at least a first set of training speech data, and wherein establishing the model of speech accent includes not using any phone or phone-class transcription of the first set of training speech data; deriving features from the speech to be recognized, the features hereinafter referred to as features for identifying accent; identifying accent of the speech to be recognized based on the features for identifying accent; and recognizing the speech to be recognized based at least in part on the identified accent of the speech.

According to another embodiment of the present invention, in an information processing system, there is a method for recognizing speech to be recognized. The method includes the steps of: identifying accent of the speech to be recognized based on the speech to be recognized; and evaluating features derived from the speech to be recognized using at least an acoustic model that has been adapted for the identified accent using training speech data from a language, other than primary language of the speech to be recognized, that is associated with the identified accent.

According to another embodiment of the present invention, there is a system for recognizing speech to be recognized. The system includes: an accent identifier that is configured to identify accent of the speech to be recognized, wherein the accent identifier comprises a model of speech accent that is established based at least in part on using certain training speech data without using any phone or phone-class transcription of the certain training speech data; and a recognizer that is configured to use models, including a model deemed appropriate for the accent identified by the accent identifier, to recognize the speech to be recognized.

According to another embodiment of the present invention, there is a system for recognizing speech to be recognized. The system includes: an accent identification module that is configured to identify accent of the speech to be recognized; and a recognizer that is configured to use models to recognize the speech to be recognized, wherein the models include at least an acoustic model that has been adapted for the identified accent using training speech data of a language, other than primary language of the speech to be recognized, that is associated with the identified accent.

### BRIEF DESCRIPTION OF THE DRAWINGS

FIG. 1A is a block diagram of a conventional speech recognition system;

FIG. 1B is a block diagram of a computer system in which the present invention may be embodied;

FIG. 2 is a block diagram of a software system of the present invention for controlling operation of the system of FIG. 1B;

FIG. 3 is a block diagram of an automatic speech recognition (ASR) system, and an associated accent identification system and accent adaptation system, according to an embodiment of the present invention.

FIG. 4 is a flow diagram of methodology for establishing an accent identifier and recognizing speech, according to an embodiment of the present invention.

FIG. 5 is a flow diagram of methodology for adapting to an accent and recognizing speech, according to an embodiment of the present invention.

### DETAILED DESCRIPTION OF A PREFERRED EMBODIMENT

The following description will focus on the currently-preferred embodiment of the present invention, which is operative in an environment typically including desktop computers, server computers, and portable computing devices, occasionally or permanently connected to one another. The currently-preferred embodiment of the present invention may be implemented in an application operating in an Internet-connected environment and running under an operating system, such as the Linux operating system, on an IBM-compatible Personal Computer (PC). The present invention, however, is not limited to any particular environment, device, or application. For example, the present invention may be advantageously embodied on a variety of different platforms, including Microsoft® Windows, Apple Macintosh, EPOC, BeOS, Solaris, UNIX, NextStep, and the like. The description of the exemplary embodiments which follows is, therefore, for the purpose of illustration and not limitation.

### I. Computer-based Implementation

A. Basic System Hardware (e.g., for Server or Desktop Computers)

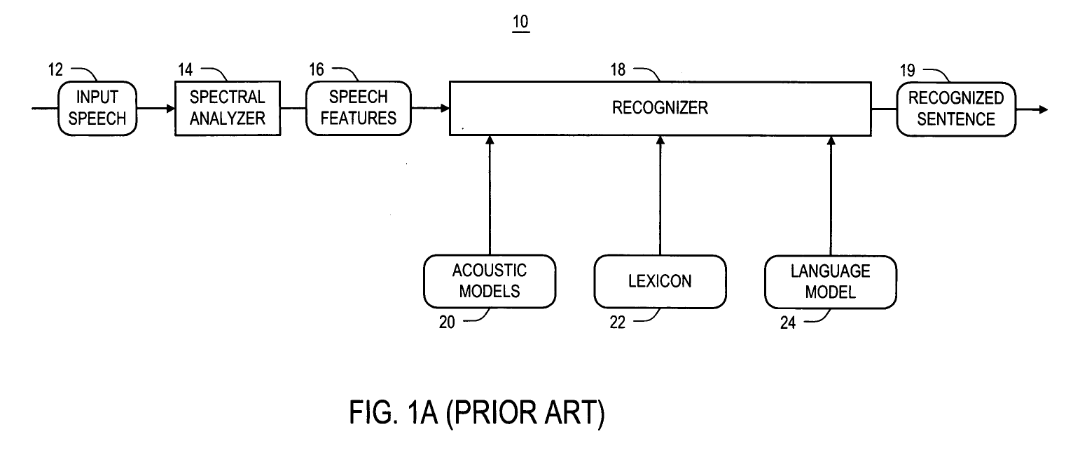

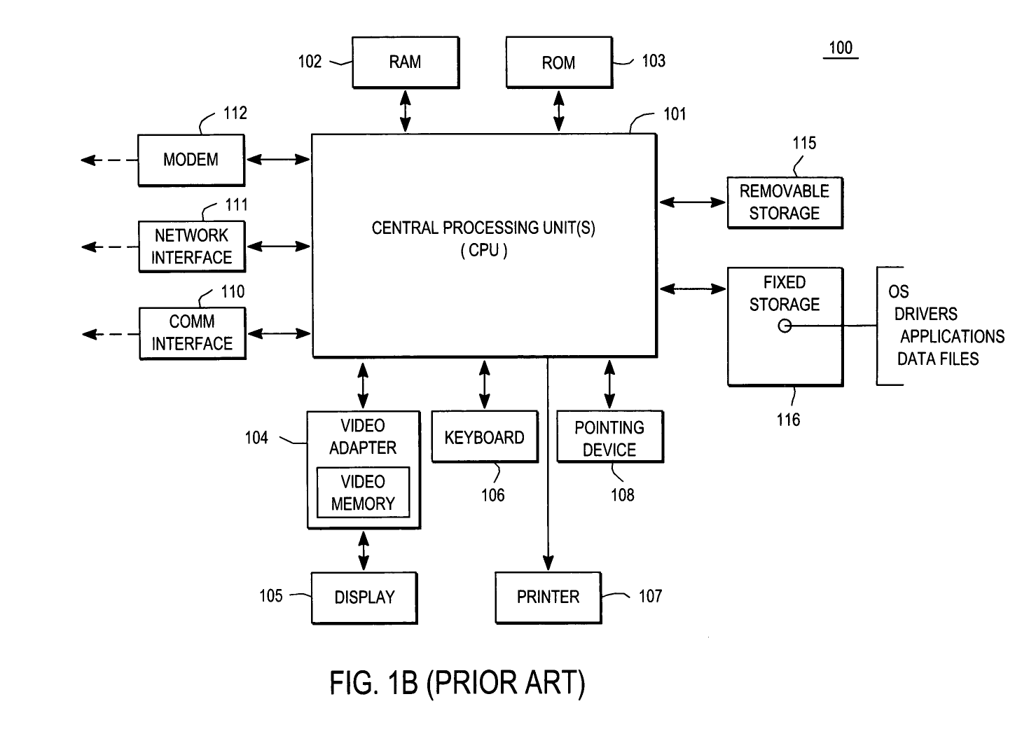

The present invention may be implemented on a conventional or general-purpose computer system, such as an IBM-compatible personal computer (PC) or server computer. FIG. 1B is a general block diagram of an IBM-compatible system 100. As shown, system 100 comprises a central processor unit(s) (CPU) 101 coupled to a random-access memory (RAM) 102, a read-only memory (ROM) 103, a keyboard 106, a pointing device 108, a display or video adapter 104 connected to a display device 105 (e.g., cathode-ray tube, liquid-crystal display, and/or the like), a removable (mass) storage device 115 (e.g., floppy disk and/or the like), a fixed (mass) storage device 116 (e.g., hard disk and/or the like), a communication port(s) or interface(s) 110, a modem 112, and a network interface card (NIC) or controller 111 (e.g., Ethernet and/or the like). Although not shown separately, a real-time system clock is included with the system 100, in a conventional manner.

In basic operation, program logic (including that which implements methodology of the present invention described below) is loaded from the storage device or mass storage 115, 116 into the main memory (RAM) 102, for execution by the CPU 101. During operation of the program logic, the system 100 accepts, as necessary, user input from a keyboard 106 and pointing device 108, as well as speech-based input from a voice recognition system (not shown). The keyboard 106 permits selection of application programs, entry of keyboard-based input or data, and selection and manipulation of individual data objects displayed on the display device 105. Likewise, the pointing device 108, such as a mouse, track ball, pen device, or the like, permits selection and manipulation of objects on the display device 105. In this manner, these input devices support manual user input for any process running on the computer system 100.

The system itself communicates with other devices (e.g., other computers) via the network interface card (NIC) 111 connected to a network (e.g., Ethernet network), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (“comm”) interface 110, which may include a RS-232 serial port, a Universal Serial Bus (USB) interface, or the like. Devices that will be commonly connected locally to the comm interface 110 include laptop computers, handheld organizers, digital cameras, and the like.

The above-described computer system 100 is presented for purposes of illustrating the basic hardware underlying desktop (client) and server computer components that may be employed in the system of the present invention. For purposes of discussion, the following description may present examples in which it will be assumed that there exists a client machine (e.g., desktop “PC”) having application software locally that, in turn, is connected to a “server” or remote device having information of interest to the ultimate end-user. The present invention, however, is not limited to any particular environment or device configuration. In particular, a client/server distinction is neither necessary to the invention nor even necessarily desirable, but is used to provide a framework for discussion. Instead, the present invention may be implemented in any type of computer system or processing environment capable of supporting the methodologies of the present invention presented in detail below. For example, interaction with the end user may be local or remote.

B. Basic System Software

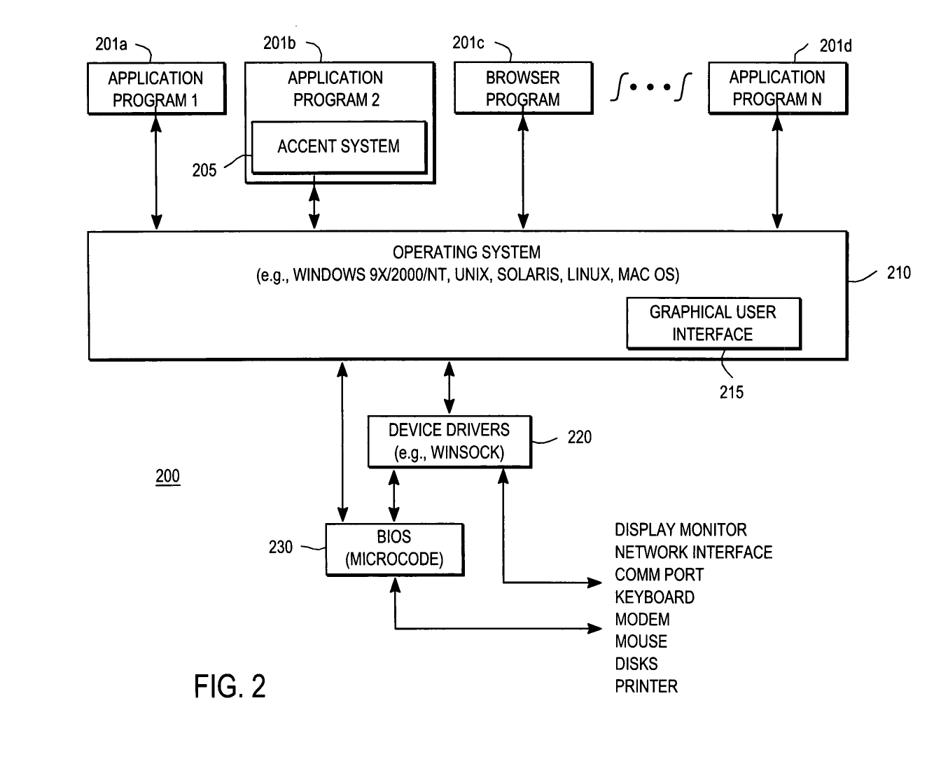

Illustrated in FIG. 2, a computer software system 200 is provided for directing the operation of the computer system 100. The software system 200, which is stored in the main memory (RAM) 102 and on the fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client or server application software or “programs” 201 (e.g., 201a, 201b, 201c, 201d) may be “loaded” (i.e., transferred from the fixed storage 116 into the main memory 102) for execution by the computer system 100.

The software system 200 preferably includes a graphical user interface (GUI) 215, for receiving user commands and data in a graphical (e.g., “point-and-click”) fashion. These inputs, in turn, may be acted upon by the computer system 100 in accordance with instructions from the operating system 210, and/or client application programs 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver) and the system BIOS microcode 230 (i.e., ROM-based microcode), particularly when interfacing with peripheral devices. The OS 210 can be provided by a conventional operating system, such as Microsoft® Windows 9x, Microsoft® Windows NT, or Microsoft® Windows 2000, all of which are available from Microsoft Corporation of Redmond, Wash., U.S.A. Alternatively, OS 210 can also be an another conventional operating system, such as Macintosh OS (available from Apple Computers of Cupertino, Calif., U.S.A.) or a Unix operating system, such as Red Hat Linux (available from Red Hat, Inc. of Durham, N.C., U.S.A.).

Of particular interest, the application program 201b of the software system 200 includes an accent classification and/or adaptation system 205 according to the present invention. Construction and operation of embodiments of the present invention, including supporting methodologies, will now be described in further detail.

### III. Underlying Speech Processing System

A. Helpful References

The present invention may be built upon a standard ASR system, e.g., one that uses Hidden Markov models (HMMs), by adding the method steps and computations described in the present document. Speech recognition systems, and HMMs, are well known in the relevant art, and are described, for example, in the following references, which are hereby incorporated by reference in their entirety for all purposes:
(1) co-owned and co-pending U.S. patent application Ser. No. 09/613,472, filed on Jul. 11, 2000 and entitled “SYSTEM AND METHODS FOR ACCEPTING USER INPUT IN A DISTRIBUTED ENVIRONMENT IN A SCALABLE MANNER”;
(2) Lawrence Rabiner & Biing-Hwang Juang; Fundamentals of Speech Recognition; Englewood Cliffs N.J.: PTR Prentice Hall (Signal Processing Series), c1993; ISBN 0-13-015157-2;
(3) X. D. Huang, Y. Ariki, M. A. Jack; Hidden Markov Models for Speech Recognition; Edinburgh: Edinburgh University Press, c1990;
(4) V. Digalakis and H. Murveit, “GENONES: Generalized Mixture-Tying in Continuous Hidden-Markov-Model-Based Speech Recognizers,” IEEE Transactions on Speech and Audio Processing, Vol. 4, July, 1996;
(5) Kai-Fu Lee; Automatic Speech Recognition: the Development of the Sphinx System; Boston, London: Kluwer Academic, c1989;
(6) T. Schalk, P. J. Foster; Speech Recognition: The Complete Practical Reference Guide; New York: Telecom Library, Inc., c1993; ISBN O-9366648-39-2; and
(7) S. E. Levinson, L. R. Rabiner and M. M. Sondhi; “An Introduction to the Application of the Theory of Probabilistic Functions of a Markov Process to Automatic Speech Recognition”, in Bell Syst. Tech. Jnl., v62(4), pp. 1035-1074, April 1983.

Other references are also shown in a later section, separately numbered from 1 to 32, and referred to as [Ref. 1] to [Ref. 32]. These other references are also incorporated by reference in their entirety for all purposes.

B. Overview

FIG. 1A shows the basic components common to most present day automatic speech recognition systems. The operation of this system is as follows: the speech data is passed through to the “Spectral Analysis” block which extract the important features related to speech recognition. This process is also called parameterization. The speech are cut into small portions, or frames, usually about 10 ms. Each of the frames will undergo frequency or spectral analysis and convert into a set feature parameters and form a observation vector. Therefore the whole speech data will be converter into a series of observation vector and represented by:

O=o₁, o₂, . . . , o_{T}

where T is the number frames.

The observation vectors are then passed to the recognizer which determines the most likely word sequence W′ for the speech data. They determination depends on the acoustics models, lexicon and language models (which will be described) later. The word sequence can be determined by maximizing the probability P(W|O) of a word sequence W given acoustic observation O, Although this is not directly computable, it may be derived via Bayes' rule [Ref. 30]:

$${W}^{′} = {arg max}_{W} P ( W \vert O ) {W}^{′} = {arg max}_{W} \frac{P ( W ) P ( O \vert W )}{P ( O )}$$

The denominator of this expression is constant over W and so further simplification is possible, thus:

$${W}^{′} = {arg max}_{W} P ( W ) P ( O \vert W )$$

The first term in this expression, P(W), is the a priori probability of the word sequence W being observed and is independent of the acoustic evidence O.

C. Acoustic Models

Acoustic models are the mathematical model that represents sounds. For example, for the word “Apple” contains the sounds /ae p l/ from dictionary. Then we may use three models to represent the sound /ae/, /p/ and /l/ respectively. The statistical distribution of the feature vectors for each sounds are computed and stored in these models.

D. Lexicon

In order to know the sounds of each words, the pronunciations of words must be provided to the recognizer. Such Information are stored in lexicon or dictionary. For example a simple lexicon may include entries such as the following, each being a word follows by its pronunciation:

| | |
|---|---|
| A | ae |
| APPLE | ae p l |
| BANNER | b ae n ax r |
| BANNER | b ae n ax |

When a word has more than one pronunciation such as “BANNER” in the example above, it will appear twice in the lexicon.

E. Language Models

Language models give information about how the words usually form a sentence. The language model used is frequently a “bigram”, which is built by counting the relative frequency that a given word A is followed by a word B. For example, we know that word “thank” is usually by the word “you”. The bigram is a conditional probability P(B|A). This information in a bigram is very useful for determining the most likely word sequence spoken by the speaker.

F. Accent Problems in ASR

A number of researchers including linguists have put a lot of effort in studying foreign accent [Refs. 18, 15, 25, 4]. It was found that each person develops a speaking style in childhood. This speaking style includes phoneme production, articulation, tongue movement and the control of vocal tract. The development is rapid in childhood and become very slowly when grow up. That is why we always say that children is fast in learning second language. It turns out that people have used to a certain set of sounds or phones. Non-native speakers preserve this speaking style when learning a second-language. When they encounter a new phones in second language. They wound try to say that sounds. Sometimes people find it was difficult because they used to a certain speaking style. The movement of tongue, lips or vocal tract cannot easily adapt to this new phones. This results in either phoneme substitution, insertion or deletion when non-native speaker try to say a new word. On the other hand, the place of stress and rhythm are also another factors that we could distinguish a non-native and native speaker. There are some physical measurement that we could describe speaking style. Since they are different between accent. Researchers try to extract them in accent classification or try to make a modification or normalization to them when doing automatic speech recognition.

G. Phoneme Inventory

Phones and Phonemes are two different things. Phones are the sounds that we actually say or heard in regards of languages and phonemes are the symbols or units try to describe some distinguishable sounds of a language. Many languages has their own set of phonemes. In other to have make comparison of accent, we need a common set of phonemes. People usually use International Phonetic Alphabet (IPA). However, IPA use some special symbols which is hard to represent in computer. We adopt the ARPABET set which is made up of alphabet. There are mappings between IPA and ARPABET. According to the movement of tongue, lips and vocal tract. The phonemes are classified into classes called phone classes. There are the following several common basic phone classes:
(1) stops,
(2) affricates,
(3) fricatives,
(4) nasals,
(5) semi-vowels & glides, and
(6) vowels.

By examine the set of IPA in each languages, we could find out which phonemes are common to each other, which are similar and which are missing. Since phoneme insertion, deletion and substitution occurs when people learning second languages, a simple lexicon contain only one accent is not proper enough to recognized accented speech. That's why there is a performance drop on speech recognition system.

H. Prosody

Prosody is defined as 1) narrowly, pertaining to distinctions of prominence in speech, particularly as realized phonetically by variation in pitch and loudness, or phonologically by the use of tone, pitch accent or stress OR 2) broadly, pertaining to any phonetic or phonological variable that can only be described with reference to a domain larger than a single segment [Ref. 28]. In other words, spectral parameters extending beyond a phoneme could be considered as prosodic parameter. Below are some of such these parameters:
(1) Energy—Energy in a broad sense defines the loudness of sounds.
(2) Formants—The resonance frequencies of the vocal tract.
(3) Pitch—Sometimes “F0”, the fundamental frequency of voicing sound, is used to represent pitch.

### IV. System Overview

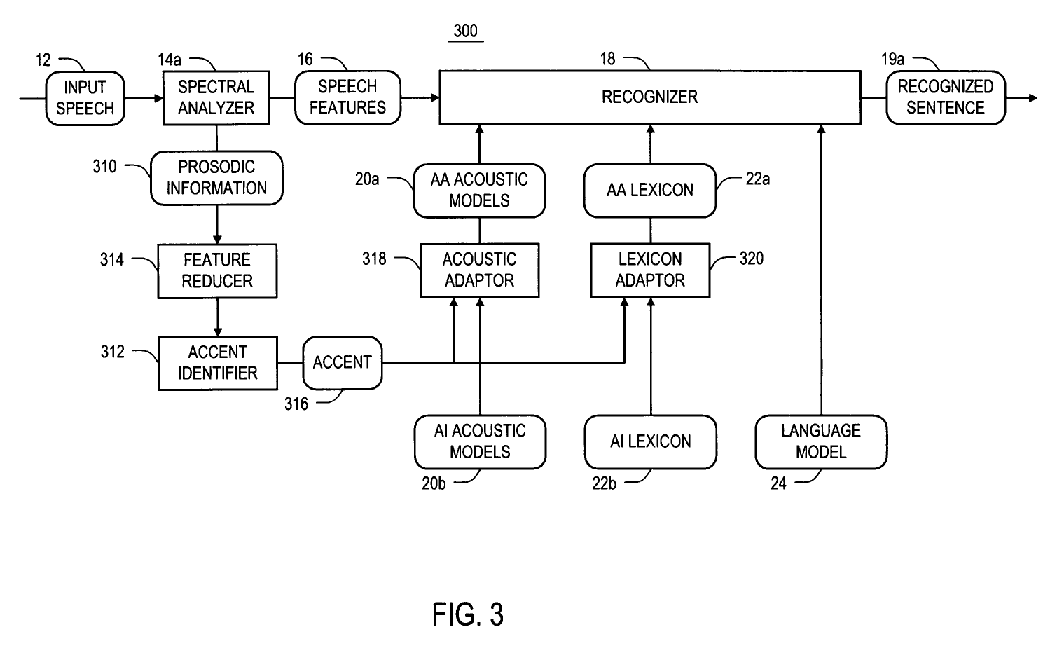

FIG. 3 is a diagram of an automatic speech recognition (ASR) system 300, and an associated accent identification system and accent adaptation system, according to an embodiment of the present invention. As in the conventional ASR system 10 of FIG. 1A, the user input speech 12 is analyzed and important parameters 16 are extracted. Further, a front-end spectral analysis block 14a also extracts prosodic information 310. The prosodic information 310 is used by an accent identifier 312 to identify the accent 316 of the input speech 12. Preferably, the prosodic information 310 is first reduced by a feature selection module 314. Based on the identified accent 316, accent-specific knowledge is selected for use by the recognizer 18 to use to obtain a hypothesized recognized sentence 19a. The accent-specific knowledge preferably includes accent-adapted (AA) acoustic models 20a and accent-adapted (AA) lexicon 22a. The AA acoustic models 20a are preferably adapted from Accent-independent (Al) acoustic models 20b, preferably using Maximum likelihood linear regression (MLLR) 318 and preferably without requiring training speech from speakers having the accent 316. The AA lexicon 22a are preferably adapted using knowledge-based adaptation 320 from an Al lexicon 20b. V. Accent Identification System

A. Train and Use Accent Models: Preferably Non-Phone, non-Phone Class

The accent identification system 312 of FIG. 3 preferably uses prosodic features, preferably including some or all of the following features and their first and second derivatives (27 features in all): fundamental frequency (F0), energy in root-mean-square (rms) value (EO), first formant frequency (F1), second formant frequency (F2), third formant frequency (F3), and the widths (B1, B2 and B3) of F1, F2 and F3, respectively.

The continuous input speech 12 of FIG. 3 is preferably sampled at 16 kHz, and high-frequency pre-emphasized, and Hamming windowed in a conventional way. Then, prosodic feature extraction is performed on a frame by frame basis. Classification is then performed using the accent model. The order of importance and preference for accent classification is: dd(E), d(E), E, d(F3), dd(F3), F3, B3, d(F0), F0, dd(F0), where E is energy, F3 is third formant, B3 is bandwidth of third formant, d( ) is the first derivative and dd( ) is the second derivative.

Accent models can be built for each accent handled by the system, and then extracted features of the input speech may be evaluated by each model, and the system may select the accent whose model produced the highest score as the identified accent. In the past, the accent model for each accent included models of the phones or phone classes (stops, affricates, fricatives, etc.) according to speech of that accent. However, training such models required phone or phone-class transcriptions (either generated by hand or by inaccurate machine recognition). Preferably, then, for the system 300 of FIG. 3, such accent models are replaced by a single HMM used to model an entire accent. The single HMM preferably does not include any states that specifically model predetermined phones or classes of phones. Such an HMM can be, and preferably is, established without using any phone or phone-class transcription. In a test system, the Foreign Accented English (FAE) corpus and Multi Language Telephone Speech (MLTS) corpus are used. These corpuses are both telephone speech database from the same site—OGI (Oregon Graduate Institute). Such an HMM can be trained using less training data than is required to train phone or phone-class HMMs. In one embodiment of the system 300 of FIG. 3, the accent model for each accent is a sequence of 3 states (or about 3 states) of a hidden Markov Model (HMM), with each state having a single Gaussian density. In that embodiment, the number of “.wav” files used from the FAE corpus from OGI, for each accent on English speech, is as follows:

| Accent | Symbol | Number of wave files |
|---|---|---|
| English | EN | 204 |
| Cantonese | CA | 261 |
| Mandarin | MA | 282 |
| Japanese | JA | 194 |
| Hindi | HI | 348 |
| Tamil | TA | 326 |
| Spanish | SP | 270 |
| French | FR | 284 |
| Malay | MY | 56 |
| Korean | KO | 169 |
| Vietnamese | VI | 134 |

The accent models are trained as follows. For each utterance, simply label its accent for training, e.g. CA for Cantonese utterance, MA for Mandarin utterance. An accent-dependent HMM is trained for each accent using the labeled training data. This approach does not require any phone level or phone class level transcriptions. This makes the training of a classifier very fast since there is no need of segmentation of phone classes during embedded training. This single HMM also reduces classification time. In addition, accent classification is not dependent on the accuracy of a phone recognizer in training this single HMM. There is no large accent database available. In FAE, only two to three hundreds telephone-quality utterances are used to train the accent model for each accent—namely, an HMM with 3 states and 1 Gaussian mixture per state.

B. Reduce the Features Using Feature Selection and/or Transformation

1. Overview

The prosodic features are useful for modeling and identifying accent of speech. However, there are relatively many features, which require much computation to use. Preferably, the accent identification system 312 of FIG. 3 reduces these features to a lower dimensionality. For example, one or both of Sequential Backward Search (SBS) or Principal Component Analysis (PCA) algorithms is used.

2. Sequential Backward Search (SBS)

With a given classifier and a given number of selected features, we search the combination of features in a sequential order to find the one that gives highest classification rate. The classification rate (CR) is used as optimization criterion. Combinations with high classification rate are selected. Procedures of SBS foraccent classification:
(1) At each level, search for the worst individual feature by masking every feature in turn and perform accent classification.
(2) Drop this worst feature and repeat the previous step until the classification rate reaches highest point.

For example, suppose there are four features 1, 2, 3, 4. All four are in a single set at the top level. At the next level, each of the four parameters is dropped in turn and a new set is formed. Thus, there are in turn four sets at the second level: (2, 3, 4), (1, 3, 4), (1, 2, 4), and (1, 2, 3). Accent classification is performed in turn using just the features of each new set. The performance is measured. Assume that dropping the second parameter gives the best classification rate in the level, then the wining set (1,3,4) is selected. The process goes on in the same manner until maximum classification rate is obtained or expected dimension of parameter is obtained. For example, the next level will include three sets, namely, (3, 4), (1, 4), and (1, 3). For example, suppose that dimension of two is expected in this example; then, the best of the three sets of the third level, perhaps (1, 4) will include the features to use for accent identification. This approach is optimized towards the final goal (high classification rate) and does not depend on the classifier. It is easy to implement and understand. However, it uses a lot of computation resources since each of the classification-rate estimating tests must be preceded by a training step.

In experiments, using 27 prosody features as the initial features and then using SBS to drop about 12 features (including, e.g., 11 or 13 features) give good results for English language for identifying Cantonese Chinese, Japanese, or Mandarin Chinese accents.

3. Principal Component Analysis

The objective of this approach is to search for a mapping of original acoustics feature set x into a new one y, using linear transformation T:

y=Tx

We find the y which best represents x with a reduced number of feature components (i.e., dimensions). These components are uncorrelated and can be found by an eigenvalue decomposition procedure. Procedures of applying PCA on accent classification using K-L transformation (Karhunen-Loeve transformation):
(1) On the training database calculate the mean vector x and covariance matrix C of the whole accent data:

x̅=E[x]

C=E[(x− x̅)^{t}(x− x̅)]
(2) Compute eigenvalues λᵢ and eigenvectors tᵢ of the covariance matrix of the acoustic parameters:

det(λI−C)=0

(λᵢI−C)tᵢ=0
(3) Make matrix T of the first R eigenvectors that have been ordered according to the decreasing values of their corresponding eigenvalues:

T=(t^{T}ᵢ. . . t^{T}_{R})

After finding the transformation matrix T, all the feature vectors of all accent data are transformed into a new space with smaller dimension. Classifiers are then trained on these transformed data. Classification is also done on the transformed test data. The advantage of PCA is its independence on the type of the target classifier.

In experiments, using 27 prosody features as the initial features and then using PCA to reduce dimensionality to about 14 dimensions (including, e.g., 13 or 16 features) give good results for English language for identifying Cantonese Chinese, Japanese, or Mandarin Chinese accents.

C. Further Description of Methodology

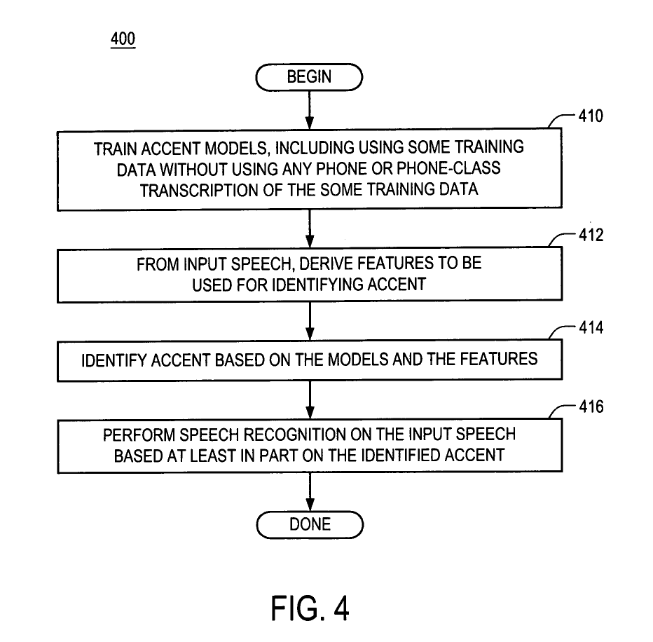

FIG. 4 is a flow diagram of methodology 400 for establishing an accent identifier and recognizing speech, according to an embodiment of the present invention. As shown in FIG. 4, in a step 410, accent models are trained using training data, including using some training data without using any phone or phone-class transcription of the some training data. In a step 412, features are produced for identifying accent. The step 412 may be performed, e.g., by the spectral analyzer 14a and/or the feature reducer 314 of FIG. 3. Preferably, the features include prosodic features, preferably reduced in dimension, as discussed above. In a step 414, the accent of the input speech is identified based on the accent models and the features. The step 414 may be performed, e.g., by the accent identifier 312 of FIG. 3. In a step 416, speech recognition is performed on the input speech based at least in part on the identified accent. The step 416 may be performed, e.g., by the speech recognizer 18 of FIG. 3. Preferably, the speech recognizer 18 of FIG. 3 uses accent adapted models to perform the step 416, as is further discussed above and below.

### VI. Accent Adaptation System

A. Lexicon Adaptation for an Accent (for Phonological Differences)

1. Overview

The knowledge-based lexicon adaptation system 320 of FIG. 3 adapts an ordinary native English lexicon 22b into a lexicon 22a for accented English speech (e.g., Cantonese accent).

Different languages, such as English and Chinese, have different inventories of phones, different grammar, different patterns of intonation and other prosodic characteristics. When a person is learning a second language, the speaking style in the first language is generally imposed on the new language. For example, when a person sees a new phone in the second language, he will substitute it with a phone from his first language or he may even simply not pronounce it. Even for the same phoneme, there is acoustics differences between native speakers and foreigner. For example, a vowel produced by foreigner typically sounds different from the same vowel uttered by a native speaker and may be similar to another vowels in the foreigner's own language.

Accent can affect the phonemes sequences for spoken words. In general there are three types of variations can be seen. They are phoneme deletion, insertion and substitution.
(1) Phoneme insertion—extra phoneme(s) is/are inserted to a word:
   (a b c) becomes (a b×c)
(2) Phoneme insertion—phoneme(s) is/are deleted in a word:
   (a b c) becomes (a c)
(3) Phoneme substitution—a phoneme or group of phonemes are replaced by another phoneme(s):
   (a b c) becomes (a×c)

2. Phoneme Mapping Using Linguistic Knowledge

In adapting a lexicon (i.e., dictionary) to add likely pronunciations by a speaker with a particular accent, the lexicon adaptation system 320 of FIG. 3 applies linguistic rules that have been produced by linguists and other experts. The rules are summarized in Tables 1a and 1b. According to the rules, add possible pronunciations for words. Although the dictionary size is doubled, speech recognition results are better for speech recognition by using the accent-adapted dictionary.

TABLE 1a
Phonetic Rules for Adapting Lexicon to Cantonese Accent

| rule | description |
|---|---|
| 1 | confusion between /l/ /n/ as the starting phones |
| 2 | deletion of the ending /l/ |
| 3 | deletion of consonant p b t dk f vm ns |
| 4 | deletion of /r/ sounds |
| 5 | /r/ is not pronounced before a consonant |
| 6 | /r/ and /ax r/ are not pronounced in the final position |
| 7 | some /r/ sounds is confused with /l/ sounds |
| 8 | deletion of TH and DH |
| 9 | confusion of (TH between F) and (DH between D) |
| 10 | confusion of th and dh |
| 11 | confusion between s and z |
| 13 | confusion between s and sh |
| 14 | after /sh/, ed is pronounced as /t/ |
| 15 | after /sh/, es is pronounced as /iz/ |
| 16 | confusion between sh and zh |
| 17 | confusion between ch and jh |
| 18 | there is no v sound in Cantonese and hence deletion |
| 19 | confusion between f and v |
| 20 | deletion of ending /d/ |

TABLE 1b
More Phonetic Rules for Adapting Lexicon to Cantonese Accent

| rule | description |
|---|---|
| 21 | deletion of ending /b/ |
| 22 | deletion of ending /g/ |
| 23 | confusion between /ae/ and /eh/ |
| 24 | /ih/ not distinguished from /iy/ |
| 25 | /ae/ not distinguished from /eh/ |
| 26 | /ah/ not distinguished from /aa/ |
| 27 | /aa/ not distinguished from /oh/ |
| 28 | /oh/ not distinguished from /ao/ |
| 29 | /uw/ not distinguished from /uh/ |
| 30 | /ey/ not distinguished from /eh/ |
| 31 | confusion of /n/ /l/ /r/ |
| 32 | /l/ as final consonant |
| 33 | /p/ and /b/ as final consonants |
| 34 | /pl/ and /bl/ mispronounced as po and bo |
| 35 | ed mispronounced as /d/ |
| 36 | /kl/ /gl/ mispronounced as ko and go |
| 37 | confusion of /w/ and /v/ |

B. Acoustic Model Adaptation for an Accent (for Acoustic Differences)

1. Overview

There are various algorithms for acoustic adaptation. These include speaker clustering [Ref. 13], spectral tranforms [Ref. 10] and model parameter adaptation [Refs. 24, 2, 23]. Researchers have used these techniques for the dialect problem [Refs. 17, 8]. Maximum likelihood linear regression [Ref. 23] (MLLR) and Maximum a posterior [Ref. 9] (MAP) are the two common techniques used in adaptation. When comparing them, MLLR is generally found to have better results when there is only small amount of adaptation data available. This is due to the fact that MLLR performs a global transformation even if few or no observation for a particular model are available. When there is much adaptation data, both techniques give comparable results. Since MLLR can work well for all cases, MLLR is preferred for acoustic model adaptation in the acoustic model adaptation system 318 of FIG. 3. Using MLLR with even only a small amount of data, a native English accent model set can be adapted to better fit the characteristics of the other accents, for example, Cantonese and Mandarin.

2. MLLR Acoustic Adaptation

Maximum likelihood linear regression or MLLR is a known method for model parameter adaptation. It finds a transformation that will reduce the mismatch between an initial model set and the adaptation data. It will transform the mean and variance parameters of a Gaussian mixture HMM system so that each state in the HMM system is more likely to generate the adaptation data. The new mean vector of the accent-adapted models is given by:

u=W s

where W is the n*(n+1) transformation matrix (where n is the dimensionality of the data) and s is the extended mean vector of the native English models, and:

s=[w; u₁; u₂; u₃; . . . uₙ]^{t}

where w represents a bias offset whose value is fixed at 1.

Hence, W can be decomposed into:

W =[b A]

where A represents an n*n transformation matrix and b represents a bias vector. The transformation matrix W is obtained by solving a maximization problem using the well known Expectation-Maximization (EM) technique. This technique is also used to compute the variance transformation matrix. Using the EM technique results in the maximization of a standard auxiliary function.

3. Adaptation Without Accented Training Data

As has been mentioned, in the speech recognition system 300 of FIG. 3, the accent of the speaker is first identified at the front end. Given the accent identification result, the system could select the appropriate acoustic models accordingly. In this fashion, the accent adaptation is preferably performed offline using supervised adaptation.

Generally however, there are no large enough accent database that is easily available. The new release Foreign Accented English (FAE) database from the OGI does not contain enough data for comprehensive study for one particular accent. Many accent researchers do their experiments on the accent database which is collected by themselves. However, speech database of the mother language (e.g. Cantonese) that gives rise to the accent (e.g., Cantonese accent) of the language (e.g., English) of the speech to be recognized is widely available and/or easy to collect. In the present system, acoustic features of accented speech can be “guessed” from the training data of the mother language. Thus, preferably, MLLR adaptation is performed using mother language data only. Supervised training uses source language data. However, the original source language data are transcribed in Cantonese phonemes. Thus, there is a problem of choosing which speech segment or Cantonese phonemes should be used to train which English phoneme models. This problem is handled as described in the following paragraph(s) using linguistic knowledge.

As mentioned above, in many applications, comprehensive accented training data is not available and/or is inconvenient to collect. In order to handle accent problem, the preferred acoustic model adaptation system 318 of FIG. 3 extracts acoustic characteristics from the mother language (e.g., Cantonese) associated with the accent (e.g. Cantonese accent) in the primary language (e.g., English) of the speech to be recognized. First, find a mapping between Cantonese phones and English phones using linguistics knowledge, as discussed above and below. Then, re-align the source language training speech data using English phonemes. Finally, adapt the native English phoneme models to accented phoneme models using MLLR adaptation, as will be further discussed. In the preceding sentences, what is meant is that a Cantonese-language lexicon that is based on Cantonese phones is converted using the linguistics knowledge into a Cantonese-language lexicon that is based on English phones, in the manner discussed above. Then, the Cantonese-language training speech is used to train acoustic models of English phones using the Cantonese-language lexicon based on English phones. In this way, the training speech data is “aligned” according to conventional terminology—i.e., aligned with English phone boundaries. In the above example, English is considered to be the primary language of the speech to be recognized if, for example, the speech to be recognized contains only English. For another example, in the above example, English is considered to be the primary of the speech to be recognized if, for example, a plurality of the words in the speech to be recognized are English words. (The other, non-plurality words may, for example, be non-English words.)

Note that at least some amount of linguistic knowledge used for adapting lexicons is generally easy to find. The reason is that, in most countries, many linguistics researchers are interested in study of the speaking behaviors of their own language and its relationship with Native English. Therefore knowledge between mother language phonemes and English phonemes are well studies by some linguistics researchers. The lexicon adaptation system 320 of FIG. 3 uses the mapping rules between Cantonese phonemes and English phonemes that are given in the book A Chinese Syllabary Pronounced According to the Dialect of Canton, written by Huang Hsi-ling Chu. The phoneme mapping suggested by Huang [Ref. 16] is summarized in Table 2.

TABLE 2
Phoneme Mapping between Cantonese and English

| Cantonese | English | Cantonese | English | Cantonese | English |
|---|---|---|---|---|---|
| aa | aa | eoi | uw | z | jh |
| aai | ay | eon | uh n | oe | er |
| aak | aa k | eot | uh t | oei | uh |
| aam | aa m | ep | ea p | oek | er k |
| aan | aa n | eu | uw | oeng | er ng |
| aang | aa ng | f | f | oi | oy |
| aap | aa p | g | g | ok | ao k |
| aat | aa t | gw | gw | on | ao n |
| aau | aw | h | h | ong | ao ng |
| ai | ay | i | iy | ot | ao t |
| ak | ax k | ik | ih k | ou | ow |
| am | ax m | im | iy m | p | p |
| an | ax n | in | iy n | s | s |
| ang | ax ng | ing | ih ng | t | t |
| ap | ax p | ip | ih p | u | uw |
| at | ax t | it | ih t | ui | uh |
| au | aw | iu | uw | uk | uh k |
| b | b | j | y | un | uw n |
| c | ch | k | k | ung | uh ng |
| d | d | kw | kw | ut | uw t |
| e | ea | l | l | w | w |
| ei | ey | m | m | yu | iy |
| ek | ea k | n | n | yun | iy n |
| em | ea m | ng | ng | yut | iy t |
| eng | ea ng | o | ao | | |

C. Further Description of Methodology

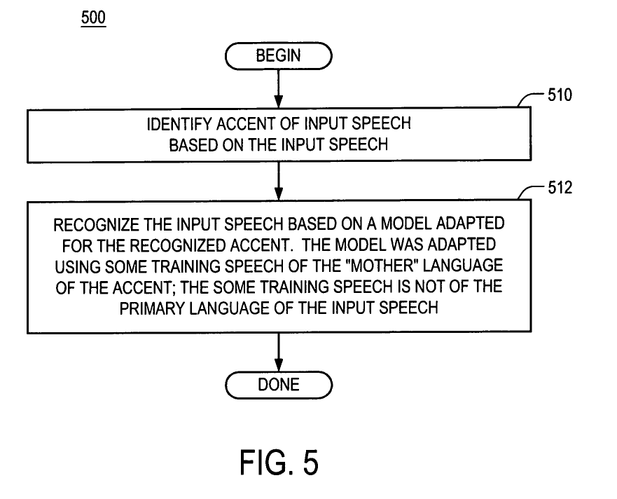

FIG. 5 is a flow diagram of methodology 500 for adapting to an accent and recognizing speech, according to an embodiment of the present invention. As shown in FIG. 5, in a step 510, accent of input speech is identified. The step 510 may be performed, e.g., by the accent identifier 312 of FIG. 3. In a step 512, the input speech is recognized based on a model adapted for the recognized accent. The model was adapted using training speech, including some training speech of a language associated with the accent, the language being substantially not of the primary language of the input speech. For example, the associated may be the “mother” language of the accent. For example, the primary language of the input speech may be English, the accent may be a Japanese accent, and the mother language of the accent may be Japanese. Further description of such preferred adaptation is found elsewhere in the present document.

### VII. Other References

Following are other references that may be of interest:
(1) Robert S. Bauer, Paul K. Benedict, Modern Cantonese Phonology, Berlin, N.Y., 1997.
(2) J. L. Gauvain, C. H. Lee, “Maximum a Posteriori Estimation for Multivariate Gaussian Mixture Observations of Markov Chains”, in IEEE Trans. Speech and Audio Processing, 1994.
(3) Kay Berkling, Marc Zissman, Julie Vonwiller, Chris Cleirign, “Improving Accent Identification Through Knowledge of English Syllable Structure”, in Proc. ICSLP98, 1998.
(4) J. J. Humphries, P. C. Woodland, D. Pearce, “Using Accent-specific Pronuniation for Robust Speech Recognition”, in Proc. ICSLP96, 1996, pages 2324-7.
(5) Pascale Fung and LIU Wai Kat, “Fast Accent Identification and Accented Speech Recognition”, in Proc. Eurospeech99, 1999.
(6) Mike V. Chan, Xin Feng, James A. Heinen, and Russel J. Niederjohn, “Classification of Speech Accents with Neural Networks”. in Proc. ICASSP94, 1994, pages 4483-6.
(7) F. Schile, A. Kipp, H. G. Tillmann, “Statistical Modeling of Pronunciation: It's Not the Model It's the Data”, in Proc. of ESCA Tutorial and Research Workshop on Modeling Pronunciation Variation for Automatic Speech Recognition, 1998.
(8) V. Diakolouwka, V. Digalakis, L. Neumeyer, J. Kaja, “Development of Dialect Specific Speech Recognisers Using Adaptation Methods”, in Proc. ICASSP97, 1997.
(9) C. H. Lee, J. L. Gauvain, “Speaker Adaptation Based on MAP Estimation of HMM Parameters”, in Proc. ICASSP93, 1993.
(10) S. J. Cox, J. S. Bridle, “Unsupervised Speaker Adptation by Probabilistic Spectrum Fitting”, in Proc. of ICASSP98, 1998.
(11) K. Kumpf K and R. W. King, “Foreign Speaker Accent Classification Using Phoneme-dependent Accent Discrimination Models and Comparisons with Human Perception Benchmarks”, in Proc. EUROSPEECH97, 1997, pages 2323-2326.
(12) C. S. Blackburn, J. P. Vonwiller, R. W. King, “Automatic Accent Classification Using Artificial Neural Networks”, in Proc. of Eurospeech, 1993.
(13) Tetsuo Kosaka, and Shigeki Sagayama, “Tree-sturctured Speaker Clustering For Fast Speaker Adaptation”, in Proc. of ICASSP94, 1994.
(14) Karstem Kumpf, and Robin W. King, “Automatic Accent Classification of Foreign Accented Australian English Speech”, in Proc. of ICSLP96, 1996.
(15) J. H. L. Hansen and L. M. Arslan, “Foreign Accent Classification Using Source Generator Based Prosodic Features”, in Proc. ICASSP95, 1995, pages 836-839.
(16) Huang Hsi ling. A Chinese Syllabary Pronounced According to the Dialect of Canton, Chung-hua shu chu, Hong Kong, 1991.
(17) V. Beattie, S. Chen, P. S. Gopalakrishnan, R. A. Gopinath, S. Maes, L. Polymenakow, “An Integrated Multi-dialect Speech Recognition System with Optional Speaker Adaptation”, in Proc. Eurospeech95, 1995.
(18) L. M. Arslan and H. L. Hansen, “Frequency Characteristics of Foreign Accented Speech”, in Proc. ICASSP97, 1997, pages 1123-1126.
(19) Levent M. Arsaln and John H. L. Hansen, “Improved Hmm Training and Scoring Strategies with Application to Accent Classification”, in Proc. ICASSP96, 1996.
(20) Levent M. Arsaln and John H. L. Hansen, “Selective Training for Hidden Markov Models with Applications to Speech Classification”, in IEEE Transactions on Speech and Audio Processing, Jan 1999.
(21) Keith Johnson and John W. Mullennix, Talker Variability in Speech Processing, Academic Press, USA, 1997.
(22) Froancois Pellegrino, Melissa Barkat, John Ohala. “Prosody as A Distinctive Feature for the Discrimination of Arabic Dialects”, in Proc. Eurospeech99, 1999.
(23) C. J. Leggetter and P. C. Woodland, “Maximum Likelihood Linear Regression for Speaker Adaptation of Continuous Density Hidden Markov Models”, in Computer Speech and Language, 1995.
(24) S. M. Ahadi, P. C. Woodland, “Rapid Speaker Adaptation Using Model Prediction”, in Proc. of ICASSP95, 1995.
(25) R. Huang, Common Errors in English Pronunciation or Cantonese Students, The Chinese University of Hong Kong, Hong Kong, 1978.
(26) R. Huang, Mastering English Pronunciation Through Phonetics and Music, Commerical Publisher, Hong Kong, 1996.
(27) Lawrence Rabiner and Biing-Hwang Jang, Fundamentals of Speech Recognition, Prentice Hall, Englewood Cliffs N.Y., 1993.
(28) R. L. Trask. A Dictionary of Phonetics and Phonology. Routledge, London and New York, 1996.
(29) P. Martland, S. P Whiteside, S. W. Beet, and L. Baghai-Ravary, “Analysis of Ten Vowel Sounds Across Gender and Regional/ Cultural Accent”, in Proc. ICSLP'96, 1996, pages 2231-4.
(30) Charles W. Therrien, Decision Estimation And Classification, John Wiley and Sons Inc., 1989.
(31) Carlos Teixeira, Isabel Trancoso, and Antonio Serralheiro, “Accent Identification”, in Proc. ICSLP96, 1996.
(32) Pascale Fung, M A Chi Yuen, and LIU Wai Kat, “Map-based Cross-language Adaptation Augmented by Linguistic Knowledge: from English to Chinese, in Proc. Eurospeech99, 1999.

### VIII. Further Comments

While the invention is described in some detail with specific reference to a single preferred embodiment and certain alternatives, there is no intent to limit the invention to that particular embodiment or those specific alternatives. For example, in addition to the preferred embodiment that handles a variety of Asian accents (e.g., Mandarin, Cantonese, Japanese, and the like) for English, the present invention may also be embodied using other accents and/or other languages. Thus, the true scope of the present invention is not limited to any one of the foregoing exemplary embodiments but is instead defined by the appended claims.

What is claimed is:

1. In an information processing system, a method for recognizing speech to be recognized, the method comprising the steps of:
maintaining a model of speech accent that is established based on training speech data, wherein the training speech data includes at least a first set of training speech data, and wherein establishing the model of speech accent includes not using any phone or phone-class transcription of the first set of training speech data;
deriving features from the speech to be recognized, the features hereinafter referred to as features for identifying accent;
identifying accent of the speech to be recognized based on the features for identifying accent and on the model of speech accent; and
recognizing the speech to be recognized based at least in part on the identified accent of the speech.

2. The method of claim 1, wherein the establishing the model of speech accent includes estimating model parameters using known accent of the first set of training speech data.

3. The method of claim 2, wherein the known accent of the first set of speech training data includes mandarin Chinese.

4. The method of claim 2, wherein the known accent of the first set of speech training data includes Cantonese Chinese.

5. The method of claim 1, wherein the model of speech accent includes a hidden Markov model trained to model an accent without states that specifically model predetermined phones or classes of phones.

6. The method of claim 1, wherein the step of recognizing the speech to be recognized based at least in part on the identified accent of the speech comprises:
deriving features, hereinafter referred to as features for recognizing speech, from the speech to be recognized; and
evaluating the features for recognizing speech using at least a speech recognition model that is deemed appropriate for the identified accent.

7. The method of claim 6, wherein the features for recognizing speech are not identical with the features for identifying accent.

8. The method of claim 7, wherein the features for identifying accent are reduced from a larger dimension of possible features.

9. The method of claim 8, wherein the features for identifying accent are reduced from a larger dimension of possible features using eigenvalue decomposition.

10. The method of claim 8, wherein the features for identifying accent are reduced from a larger dimension of possible features by determining and dropping less-useful possible features during training.

11. The method of claim 6, wherein the speech recognition model that is deemed appropriate for the identified accent includes an acoustic model that has been adapted for the identified accent.

12. The method of claim 11, wherein the acoustic model that has been adapted for the identified accent was adapted without using accented training speech data.

13. The method of claim 11, wherein the acoustic model that has been adapted for the identified accent was adapted using training speech data of a language, other than language of the speech to be recognized, that is associated with the identified accent.

14. The method of claim 13, wherein the language of the speech to be recognized is English, and the language that is associated with the identified accent is mandarin Chinese if the identified accent is a mandarin Chinese accent.

15. In an information processing system, a method for recognizing speech to be recognized, the method comprising the steps of:
identifying accent of the speech to be recognized based on information derived from the speech to be recognized; and
evaluating features derived from the speech to be recognized using at least an acoustic model that has been adapted for the identified accent using training speech data from a language, other than primary language of the speech to be recognized, that is associated with the identified accent.

16. The method of claim 15, wherein the language of the speech to be recognized is English, and the language that is associated with the identified accent is mandarin Chinese if the identified accent is a mandarin Chinese accent.

17. The method of claim 16, wherein the language that is associated with the identified accent is Cantonese Chinese if the identified accent is a Cantonese Chinese accent.

18. The method of claim 15, wherein adapting the acoustic model that has been adapted included transforming phonetic transcriptions of the training speech data, from the language that is associated with the identified accent, into phonetic transcriptions according to the language of the speech to be recognized, and then using the result as if it were training speech data of accented speech for model adaptation.

19. A system for recognizing speech to be recognized, the system comprising:
an accent identifier that is configured to identify accent of the speech to be recognized, wherein the accent identifier comprises a model of speech accent that is established based at least in part on using certain training speech data without using any phone or phone-class transcription of the certain training speech data; and
a recognizer that is configured to use models, including a model deemed appropriate for the accent identified by the accent identifier, to recognize the speech to be recognized.

20. The system of claim 19, wherein the model of speech accent is established based at least in part on using the certain training speech data and using known accent of the certain training speech data.

21. The system of claim 20, wherein the certain speech training data includes mandarin Chinese-accented training data.

22. The system of claim 21, wherein the certain speech training data further includes Cantonese Chinese-accented training data.

23. The system of claim 19, wherein the model of speech accent includes a hidden Markov model trained to model an accent and not predetermined individual phones or classes of phones.

24. The system of claim 19, wherein the accent identifier comprises an analyzer that derives features from the speech to be recognized, and the features are features that have been reduced from a larger dimension of possible features.

25. The system of claim 24, wherein the features have been reduced from a larger dimension of possible features using eigenvalue decomposition.

26. The system of claim 25, wherein the features have been reduced from a larger dimension of possible features by determining and dropping less-useful possible features during training.

27. The system of claim 19, wherein the model that is deemed appropriate for the identified accent includes an acoustic model that has been adapted for the identified accent.

28. The system of claim 27, wherein the acoustic model that has been adapted for the identified accent was adapted without using accented training data.

29. The system of claim 27, wherein the acoustic model that has been adapted for the identified accent was adapted using training data from a language, other than primary language of the speech to be recognized, that is associated with the identified accent.

30. The system of claim 29, wherein the language of the speech to be recognized is English, and the language that is associated with the identified accent is mandarin Chinese if the identified accent is a mandarin Chinese accent, and the language that is associated with the identified accent is Cantonese Chinese if the identified accent is a Cantonese Chinese accent.

31. A system for recognizing speech to be recognized, the system comprising:
an accent identification module that is configured to identify accent of the speech to be recognized; and
a recognizer that is configured to use models to recognize the speech to be recognized, wherein the models include at least an acoustic model that has been adapted for the identified accent using training speech data of a language, other than primary language of the speech to be recognized, that is associated with the identified accent.

32. The system of claim 31, wherein the language of the speech to be recognized is English, and the language that is associated with the identified accent is mandarin Chinese if the identified accent is a mandarin Chinese accent.

33. The system of claim 32, wherein the language that is associated with the identified accent is Cantonese Chinese if the identified accent is a Cantonese Chinese accent.

34. The system of claim 31, wherein the acoustic model that has been adapted was adapted by transforming phonetic transcriptions of the training speech data, from the language that is associated with the identified accent, into phonetic transcriptions according to the language of the speech to be recognized, and then using the result as if it were training speech data of accented speech for model adaptation.
